(19) United States
(12) Patent Application Publication
(10) Pub. No.: US 2009/0322761 A1
(43) Pub. Date: Dec. 31, 2009

(54) APPLICATIONS FOR MOBILE COMPUTING DEVICES

(76) Inventor: Anthony Phills, Westwood, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/255,891

(22) Filed: Oct. 22, 2008

Related U.S. Application Data
(60) Provisional application No. 61/076,133, filed on Jun. 26, 2008.

(51) Int. Cl. G06T 15/70; H04M 1/00; A63F 13/00

(52) U.S. Cl. 345/473; 455/566; 463/37

(57) ABSTRACT

A sequence of images is displayed in response to user input, such as an answer to a question, a touch and drag operation, a tap operation or shaking of a mobile device. The images may be displayed in an order determined by a direction implied by the user input, and may be accompanied by music. The display of the sequence of images may continue for a time determined by the shaking of the device prior to commencement of the display of the sequence of images. The sequence of images may depict a common constituent in successively different poses or states.

### RELATED APPLICATION

This application is a nonprovisional of and claims priority to U.S. Provisional Patent Application 61/076,133, filed Jun. 26, 2008, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to the field of applications for mobile computing devices, such as mobile phones, personal digital assistants, portable media players and the like, and more particularly to entertainment applications for such mobile computing devices.

### BACKGROUND

The advent of mobile computing devices such as the BlackBerry™ and iPhone™ have occasioned a significant increase in the number of applications being developed for these platforms. While many such applications have a business purpose, some are intended simply for user entertainment. To date, most of these entertainment applications have focused on the display of rich graphical environments similar to those found in video games and the like. Other entertainment applications involve the playing of movies, television programs and music.

### SUMMARY OF THE INVENTION

The present invention provides for displaying, in response to user input, a sequence of images on a display of a mobile device, wherein the sequence of images a common constituent in successively different poses or states and the user input comprises entering an answer to a question, or performing at least one of: a touch and drag operation or a tap operation, or shaking of the mobile device. The images may be displayed in an order determined by a direction implied by the user input, for example a direction of the touch and drag operation or the shaking. The sequence in which the images are displayed may he determined by a user input other than the touch and drag operation, the tap operation or the shaking of the mobile device, and may, in some cases, be accompanied by music. In one particular instance, the sequence of images is displayed in response to the shaking of the device and an additional user input, for example an indication that the display of the sequence of images should commence. The display of the sequence of images may continue for a time determined by the shaking of the device prior to commencement of the display of the sequence of images. Some of the images may be advertisements or advertisements may accompany the display of the images.

### BRIEF DESCRIPTION OF THE DRAWINGS

The present invention is illustrated by way of example, and not limitation, in the figures of the accompanying drawings, in which:

FIG. 1 depicts a block diagram of a system 10, configured according to one embodiment of the invention.

FIG. 2 illustrates an example of the display of a sequence of images on a mobile computing device in accordance with embodiments of the present invention.

FIGS. 3A and 3B are flow diagrams illustrating examples of processes for displaying sequences of images in response to user input in accordance with embodiments of the present invention.

FIG. 4 is a flow diagram illustrating a further example of a process for displaying sequences of images in response to user input in accordance with embodiments of the present invention.

FIGS. 5A-5F are examples of user interfaces to prompt user input for the displaying of sequences of images in response thereto in accordance with embodiments of the present invention.

FIGS. 6A-6c illustrate additional examples of user interfaces to prompt user input for the displaying of sequences of images (this time designed to simulate pieces of a jigsaw puzzle) in response thereto in accordance with embodiments of the present invention

### DETAILED DESCRIPTION

A system, variously a mobile phone, a personal digital assistant, a portable music player, a portable computer, a portable camera, or similar device, hereinafter collectively referred to as a “device”, configured in accordance with embodiments of the present invention is configured to display a sequence of images in response to user manipulation of the device. More specifically, various ones of the images are displayed in sequence (or in an order other than sequential, e.g., random, pseudo random, or determined by a measure of the input applied to the device or other factor) on a display of the device responsive to user manipulation of the device. The user manipulation may take the form of oscillating (e.g., shaking) the device, manipulating a cursor control interface (e.g., a trackball), manipulating one or more human input interfaces (e.g., buttons, switches, a touch screen, etc.), or voice commands input via a microphone. In the description below, reference will be made to shaking a device configured with accelerometers or other sensors that allow for registering such user manipulation, but any of the above forms of input should be understood to be encompassed within the broader scope of the invention.

In one particular embodiment of the invention, the sequence of images depict a human model wearing successively fewer articles of clothing. Thus, shaking the device causes the sequence of images to be displayed so as to suggest that the model removes articles of clothes in response to the shaking. In some instances the sequence of images begins playing as soon as the shaking commences, but in other cases the amount (or vigorousness) of shaking is measured and translated by the device into a stored metric (e.g., “energy”) and the sequence of images played out to a point according to the value of the stored metric. For example, if a user shakes the device sufficiently to store 50% energy (where energy is used simply as a term of convenience and should not necessarily be inferred to represent a true measure of energy imparted by the user manipulation), then one half of the sequence of images that make up a complete image collection will be subsequently played (e.g., in response to a separate user input indicating a desired to commence the playing of the image sequence). The amount of stored “energy” may be presented to the user so that s/he knows how much more shaking (or other manipulation) is required in order to achieve a desired length of image sequence play.

More generally, the present invention provides for a sequence of images to advance in display in response to user input. The sequence of images may be a deterministic sequence (i.e., the same sequence of images may be displayed every time), or a non-deterministic sequence (i.e., the order in which the images are presented may vary from one playing to another). Different sequences of images may be collected in a collection or set, and different sets of images may be stored on computer-readable media within or accessible by the device. Various forms of user input or manipulation may be used, including, but not limited to, the manipulation of a user manipulable component such as a trackball and/or the displacement of one or more spatial displacement sensors, such as accelerometers. In some cases, touch screen inputs in the form of gestures may be used as user inputs.

FIG. 1 depicts a block diagram of a system 10, configured according to one embodiment of the invention. System 10 may be a mobile computing device, such as mobile phone, personal digital assistant, portable media player or the like. System 10 includes at least one of a user-manipulable component 11 (e.g., a trackball, touch screen, joystick, etc.) and at least one spatial displacement sensor 12 (e.g., an accelerometer, which may be a multi-axis accelerometer) communicatively connected to a computing device 13. More generally, system 10 may include one or more user-manipulable components 11, one or more spatial displacement sensors 12, or a combination of user-manipulable components 11 and spatial displacement sensors 12 interfaced with computing device 13.

Computing device 13 contains repository 15, which is adapted to store digital images and/or computer readable instructions. For example, repository 15 may be a computer-readable medium (such as a solid state memory) storing computer-readable instructions, which instructions, when executed by computing device 13, cause the computing device to perform operations that result in the display of images in response to user manipulations of system 10 as discussed herein. Other examples of computer readable media suitable for use in accordance with the present invention include random-access memories (RAMs), read-only memories (ROMs), erasable programmable read-only memories (EPROMs), electrically erasable programmable read-only memories (EEPROMs), and magnetic disks, or combinations thereof, to name a few. The present invention is not limited to the use of one particular form of device or form of computing device or computer-readable memory

To facilitate the display of the images, computing device 13 is further interfaced with display 14. Display 14 may be a liquid crystal display (LCD), a touch-screen display, or a reflective display based on interferometric modulation (IMOD) technology. The interfaces between components 11-15 include, but are not limited to, electrical, wireless, and/or optical interfaces.

As indicated above, in one instance the sequence of images which computing device 13 is programmed to display concern a human being. In each of a successive one of the images, that individual is shown with successively fewer articles of clothing. Consequently, as the images are presented one by one in response to the user input (e.g., the scrolling of a trackball, the shaking of the device, etc.), the individual depicted in the images appears to the user to be disrobing in response to the user input. That is, the sequence of images in a particular set advances in response to the user input (or in accordance with an amount of “energy” stored in response to user inputs) and the details shown in the individual images that make up the sequence are successively revealed to the user. One example of a process for implementing this behavior (e.g., through execution of appropriate computer-readable instructions) is discussed below in connection with a description of various flow diagrams.

To a user, the effect of having the sequence of images presented is not unlike the experience of using a novelty pen in which an image of a clothed person is embedded within a barrel of the pen and, when the pen is inverted, the clothing in the image falls away to reveal an unclothed instance of the image of the person. If the pen is inverted again, the clothing is replaced. Similarly, in the case of the present invention, one set of user inputs sensed by the computing device may case the sequence of images to proceed in one direction (presenting an individual wearing successively fewer articles of clothing) and another set of user inputs may cause the images to play in the reverse direction (presenting an individual wearing successively more articles of clothing). In one example, rolling a trackball in one direction causes the sequence of images to play in a “forward” direction and rolling the trackball in the opposite direction causes the sequence of images to play in a “reverse” direction. Many other variants of this playing forwards and backwards are possible and the invention is not limited to just two-dimensional control of the playing of sequences of images. For example, different sets of images may be presented if the user input is made in a direction orthogonal to an original input (similar to turning pages in a book).

In one embodiment, one or more of elements 11-15 may be included in a mobile computing device including, but not limited to, an iPhone™ or iPod™ (available from Apple™ of Cupertino, Calif.) a smartphone, a cellular or other mobile phone, a BlackBerry™ (available from Research in Motion™ of Waterloo, ON), a calculator, a watch, a graphing calculator, a wireless Wii™ remote control (available from Nintendo™ Company Co., Ltd. of Koyoto, Japan), or other device or remote control. Thus, elements 11-15 of system 10 may be integrated on a single device, or may be located on separate devices or in separate modules. For example, user manipulable component 11 and spatial displacement sensor 12 may be located on a wireless Wii remote control, computing device 13 may be located in a Wii video game console communicatively coupled to the Wii remote control, and display 14 may be a television or other display device communicatively coupled to the Wii console.

A user-manipulable component includes, but is not limited to, a clicker, a key, a scroll wheel, a slider, a button, a trackball, a turnable knob, or a touch-screen display. More user-manipulable components include the scroll wheel on an iPod, and the trackball on a mobile computing device. A spatial displacement sensor includes, but is not limited to, an accelerometer, a gyroscope, a global positioning system (GPS) receiver, and a light sensor.

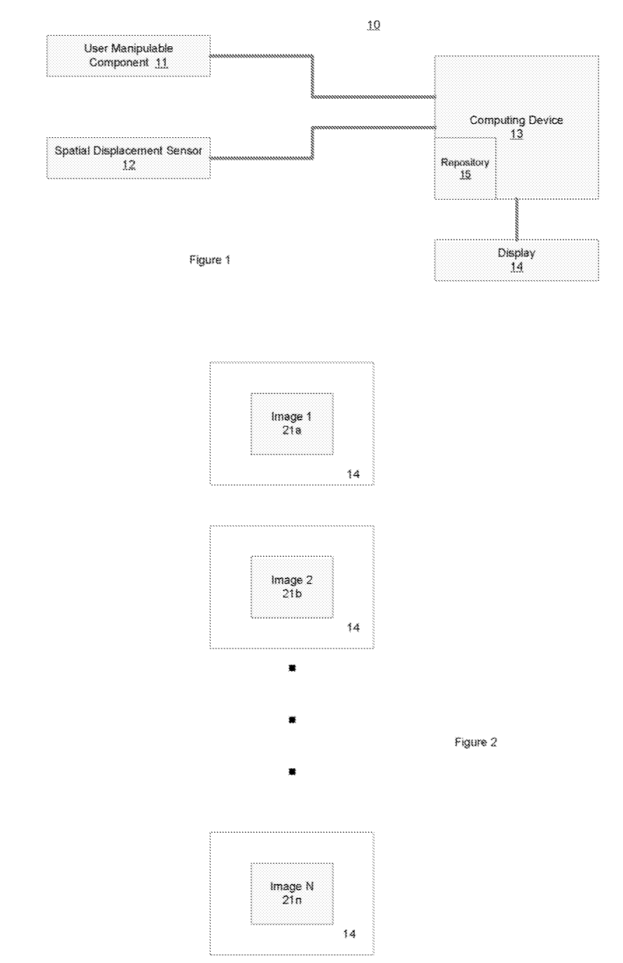

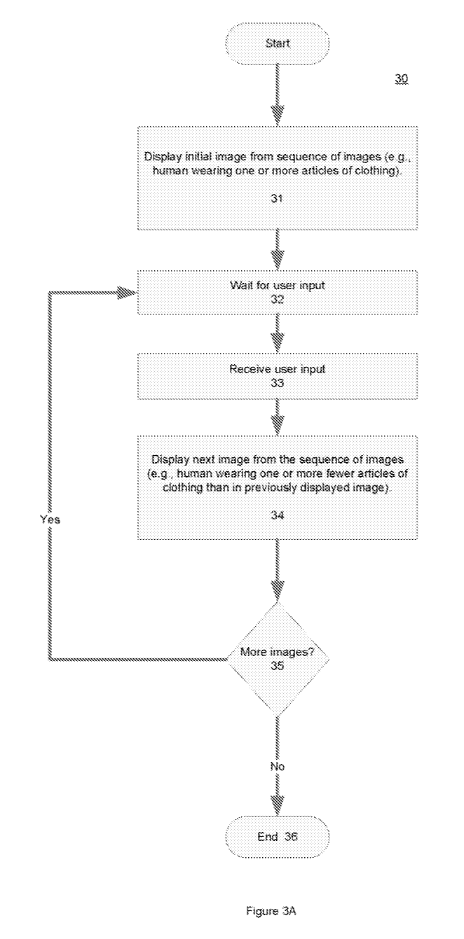

In one embodiment of the invention, a sequence of images, such as those depicted in FIG. 2, is displayed on display 14. Image 1 (21a) depicts the first image from the sequence of images; Image 2 (21b) depicts the second image from the sequence of images; and Image N (21n) depicts the final image from the sequence of images, where N is a natural number. Image 1 may depict a human wearing one or more articles of clothing; image 2 may depict the human wearing one or more fewer articles of clothing than were present in image 1; and image N may depict the human wearing one or more fewer articles of clothing than were present in image 2. In one embodiment of the invention, Image N may depict a human wearing no articles of clothing. It is understood that the same human may be depicted throughout the sequence of images. It is also possible for different humans to be depicted through the sequence of images. More generally, within any given sequence of images each image may depict a common constituent (e.g., a person, an animal, an object, etc.) in successively different poses or states.

An article of clothing includes, but is not limited to, a T-shirt, a jacket, a vest, a sweater, pants, shorts, a hat, socks, an apron, a dress, and underwear. In another embodiment of the invention, articles other than clothing may be worn by the human including, but not limited to, jewelry, a pair of shoes, and eyeglasses. The individual depicted in the sequence of images may be a male or a female. In another embodiment of the invention, images 21a-21n each include one or more humans. Images 21a-21n may depict an illustration or a photograph of a human wearing one or more articles of clothing.

For example, image 1 may depict a female wearing a hat, a dress, and socks. Image 2 may depict the female wearing a hat and socks. Finally, image N may depict the female wearing no articles of clothing. Note, at one or more points in the display of the sequence of images, an audio file may be played to provide additional user entertainment.

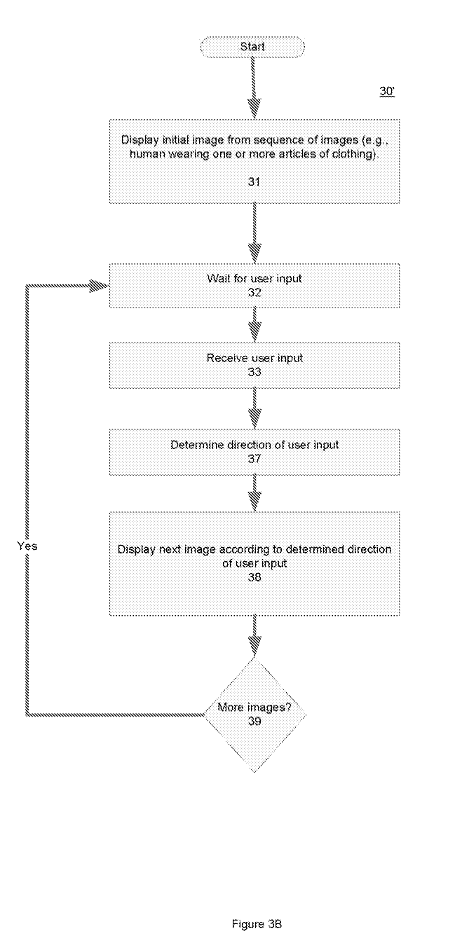

FIG. 3A illustrates one example of a process 30 for presenting a sequence of images to a user via a display of a device according to the present invention. An initial image, from a sequence of images (e.g., depicting a human wearing one or more articles of clothing) is displayed on display 14 (step 31). This display of the initial image may be responsive to a user activating an application program configured to presentation of the sequence of images responsive to user input. For example, the user may launch an appropriate application by selecting same from a menu or by selecting an icon. In other instances, the user may launch the application using a voice command. Such methods for initiating an application are not critical to the present invention, but are all contemplated within the scope thereof.

System 10 waits for user input (step 32). The user input may be received by user manipulable component 11 or spatial displacement sensor 12 (step 33). In response to the user input, a next image from the sequence of images is displayed on display 14 (step 34). This next image may, in one example, depict the human shown in the previous image wearing one or more fewer articles of clothing than was the case in the previous image in the sequence. Alternatively, if the images are shown in a sequence other than a linear order, the human may be wearing more articles of clothing than was the case in the previous image displayed to the user. In some instances, the device may measure the user's interaction with the application and determine what image from the sequence of images to display, for example, in response to a particularly violent input (perhaps representative of an impatient user), the next image displayed may be the last image in the sequence (depicting the human without any articles of clothing). Alternatively, if there is a long delay between user inputs, the user may be penalized and the next image may be of the human wearing even more articles of clothing than was the case for the previously displayed image. Many forms of games can be implemented around this notion of sequential display of images and the present invention is not restricted to only one or a few such games. Some of the games may involve the user agreeing to view certain advertising in conjunction with or between the display of desired images and the user may only be permitted to view the nest image in a sequence of images after viewing one or more advertisements. Although these sorts of games are not highlighted in the figure, they are contemplated within the scope of the present invention.

If there are more images in the sequence available to be displayed (step 34), system 10, once again, waits for user input (step 32). Otherwise, the process terminates (step 36) once all the images in a particular sequence have been displayed. Note, in some cases, the display of images has been referred to as the playing thereof, but it is important to recognize that the present invention involves the display of discrete images and not the playing of a movie or movie clip, which itself may be a sequence of images but which are intended to be played sequentially, one after the other, without a pause or interruption therebetween (even though user controls may permit paying on a particular image in the movie). The difference is more than semantics. Different file types and players are involved.

Note that not shown in this illustration, but shown in connection with process 30′ in FIG. 3B, is an example of the process where images may be played in either a forward or a backwards direction (within the sequence of images). That is, prior to playing a particular image from the sequence (step 38), the computing device may determine which next image to present based on the type or direction of user input received (step 37). If the user input is in the forward direction, the next forward image is played. If the user input is in the reverse direction, the next backwards image is played. If the user input is in an orthogonal (e.g., left or right) direction, a first image of a new sequence of images may be played (the first image may be the initial image of a sequence or an image from a point in the new sequence that corresponds to a point in the current sequence). As before, if there are more images to play the system permits further user input (step 39). Since there will always be further images (e.g., even if only in the reverse direction), play may continue until the user quits the application (e.g., by selecting a quit function or menu command (not shown)).

In other examples, the images of a sequence are played one by one, regardless of the speed or displacement of the user input, whereas in other cases the speed and/or displacement of the user input may determine from how far ahead (or behind) in the sequence the next image for presentation is selected. This way, impatient users may be accommodated. In one particular instance of the process, the sequence of images is displayed on a mobile computing device, such as a handheld device, and the user-manipulable component is a trackball. The rate at which the user rolls the trackball is correlated with the rate at which the sequence of images advances. Thus, if a user rolls the trackball at a fast rate, the sequence of images advances at a fast rate. In other cases, the shaking of a device controls the presentation of images and images within the sequence may be presented in accordance with the amount of shaking provided by the user (e.g., as measured by an accelerometer over a predetermined time interval or other means).

Still another example of a process 40 configured in accordance with an embodiment of the present invention is shown in the flow diagram depicted in FIG. 4. An initial image (e.g., one depicting a human wearing one or more articles of clothing) is displayed on display 14 (step 41). System 10 waits for spatial displacement (step 42). Spatial displacement is sensed by spatial displacement sensor 12 (step 43). In response to spatial displacement, a next image depicting the human wearing one or more fewer articles of clothing than was the case for the previously displayed image is displayed on display 14 (step 44). This process continues (step 45), for as long as there are images to display and as long as further spatial displacement (step 42) is provided. When there are no more images for display, the process terminates (step 46). As was the case for the examples discussed above, different forms of input may determine the direction in which the sequence of images is played and/or from which of sequence of images the next image is played. For example, displacing the device up and down may cause playing of images from a current sequence of images, while displacement of the device left and right may cause switching to a different sequence of images. Displacement of the device in a front and back or circular manner may cause still other display sequences to be initiated (e.g., restarting the sequence, going backwards within a sequence, displaying an image out of linear order within a sequence, etc.).

In one particular instance of the process depicted in flow diagram 40, the images are displayed on an iPhone. Shaking of the iPhone, or another delivery of spatial displacement of the iPhone (e.g, receiving input from the iPhone's GPS sensor indicating that it has moved to a new geographic location sufficiently displaced from a previous location at which a previous image was displayed), results in the display of the next image. The velocity or acceleration of the iPhone, or magnitude or direction of displacement of the iPhone may be correlated with the number of images within a sequence of images to skip ahead (or back) for display of a next image on the iPhone. Similar instances of the process depicted in flow diagram 40 may be utilized with a Wii remote control, or other system having spatial displacement sensor 12. The use of GPS sensor input may be particularly advantageous when the game involved with the display of images is a scavenger hunt or similar game involving the movement of the device (and its user) over large geographic areas and the sequence of images is a set of clues to finding items for collection or other items of interest. For example, the game may be sponsored by a business that wants to lead customers to its establishment and as the user approaches the establishment s/he is rewarded by revealing a next image in a sequence.

Another example involves the use of a virtual slider control with an iPhone or similar touch screen. Together with the images is displayed a virtual slider control which allows the user to input control using a finger that is held against the touch screen and dragged in one direction or another. Responsive to this input, the sequence of images plays in one direction or another.

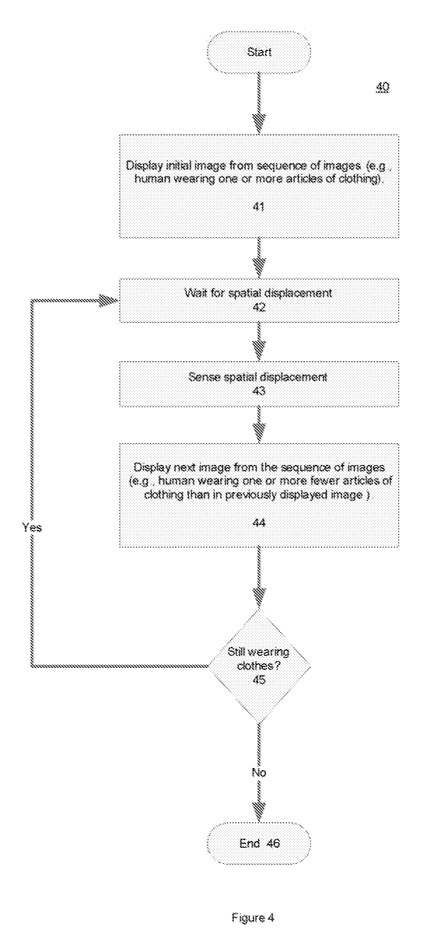

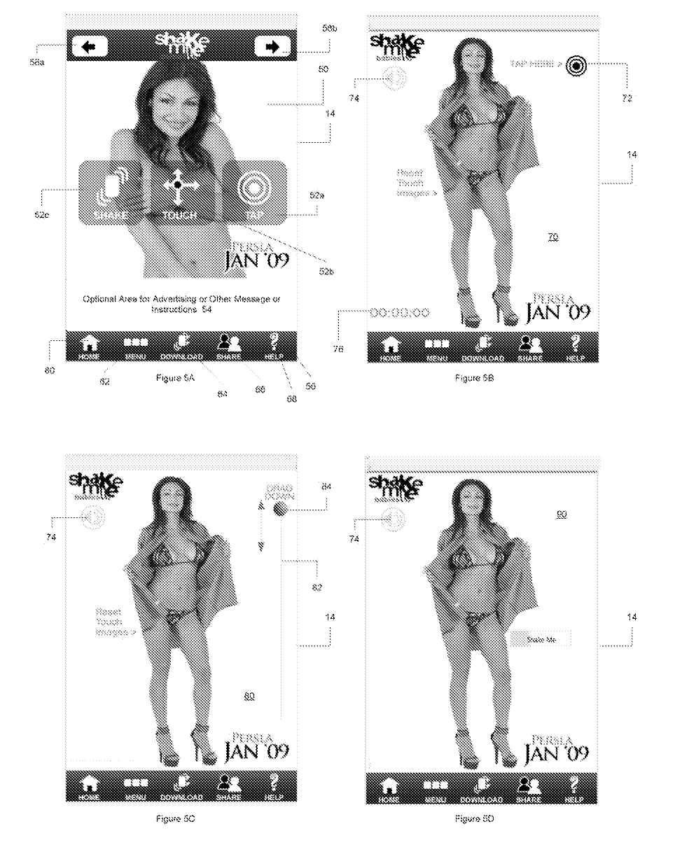

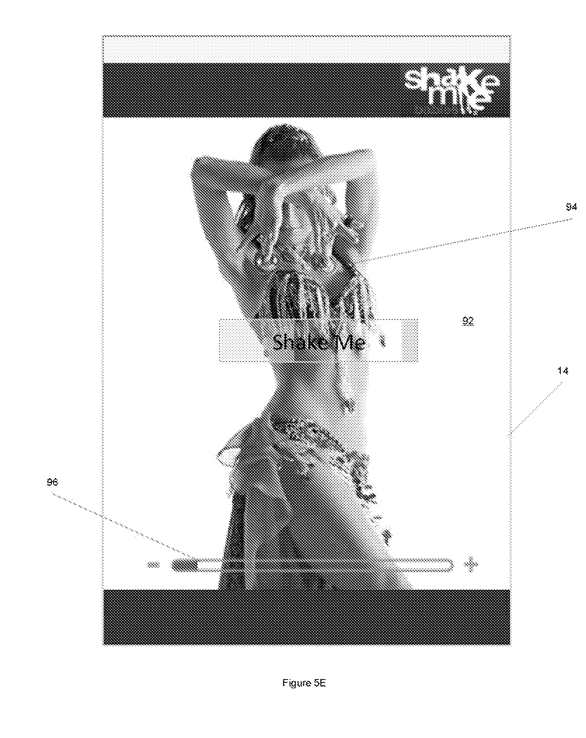

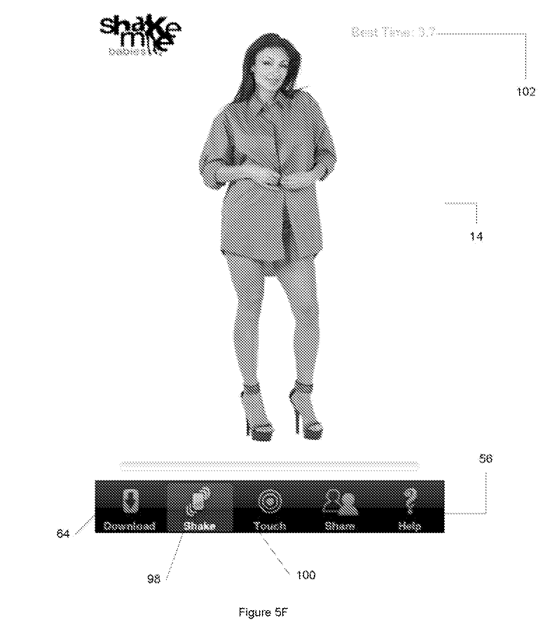

FIGS. 5A-5D illustrate some specific examples of user interfaces for use with iPhones or similar devices (e.g., devices having touch screens and/or spatial displacement sensors). In FIG. 5A an image 50 is shown on display 14. Image 50 may be an initial image that is displayed when an application is launched on the device. Also displayed at this time are three icons, 52a, 52b and 52c, which allow the user to designate what form of input will be used in order to play the sequence of images associated with the application. Icon 52a corresponds to tap inputs (i.e., direct input via the touch screen), icon 52b corresponds to touch and drag input (via the touch screen), and icon 52c corresponds to shake input (via the spatial displacement sensor of the iPhone). Alternatively, or in addition, shake, touch and/or tap icons may be included in a toolbar (such as toolbar 56).

Also shown in this illustration is an optional area 54 for presenting advertisements (e.g., of game sponsors), or other messages or instructions. Also, a toolbar 56 and navigation arrows 58a, 58b are part of the user interface. Navigation arrows 58a and 58b allow a user to scroll among different sets of sequences of images. For example, sets that correspond to months of a year (e.g., for a calendar based application) may be selected through appropriate manipulation of arrows 58a and 58b. These navigation arrows may be actuated by touching same (for a touch screen interface) or by actuating corresponding buttons or other user-manipulable elements of the subject device.

Toolbar 56 includes icons associated with a variety of user functions. For example, there may be icons for exiting the application and return to a home screen of the device 60, for displaying a menu (that provides additional user options) 62, for initiating a download of application-related materials (e.g., additional sets of images) 64, for sharing information with others (e.g., via a messaging or other communication facility of the host device) 66, and for getting assistance (e.g., in the form of a user's manual or other instructions) 68. Of course, these are only examples of the types of tools that may be provided via the toolbar and the present invention is not limited to this particular implementation of same.

In response to user selection of the tap icon 52a, the application may present the user with the tap interface 70, illustrated in FIG. 5B. Tap interface 70 includes a tap target 72, which serves as a user input station. By selecting the tap target 72 (e.g., by tapping same with a finger), the user will provide the input needed to advance the sequence of images in the fashions described above. The images may be displayed according to how quickly the user taps the tap target. Or, tapping may have to be synchronized with music or visual indicators presented to the user in order to advance the playing of the sequence of images. To reset the images to the beginning of the sequence, the user may tap the screen at another location other than the tap target 72 (e.g., the main portion of the displayed image or elsewhere on the screen). Musical accompaniment may be initiated by selecting the audio button 74. This may initiate playing of audio files stored on the subject iPhone or streamed from another source. For example, the audio button may be configured to play selections from the iPod portion of the iPhone or to play audio via another player such as the Pandora™ player available from the Music Genome Project™. A counter 76 may be provided to indicate the number of images played, the number of images remaining in a sequence, the time before a next image can be played, the time of play, or other time or item of interest.

In response to user selection of the touch icon 52b (FIG. 5A), the application may present the user with the touch interface 80, illustrated in FIG. 5C. Touch interface 80 includes a scroll bar 82, which serves as a user input station. That is, by touching and dragging the scroll button 84 along the scroll bar 82, the user can control the playing of images in the manner discussed above. The images of a sequence may be played according to the speed and direction of the displacement of scroll button 84 along the scroll bar 82. As before, the sequence may be resent to the beginning by touching the display at a different location and musical accompaniment may be provided in response to appropriate user input.

In response to user selection of the shake icon 52c (FIG. 5A), the application may present the user with the shake interface 90, illustrated in FIG. 5C. Shake interface 90 works in conjunction with user input provided via the spatial displacement sensor for the iPhone. Images are played, as discussed above, according to the manner of shaking of the device (as recorded by the spatial displacement sensor).

A variation of the shake interface is shown in FIG. 5E. Here, shake interface 92 includes an initial image 94 of a sequence of images and a energy bar 96 that shows the state of stored energy for the current game play. As a user shakes the device, “energy” will build up and the state of stored energy will be reflected in the energy bar 96 (e.g., the filled portion of the energy bar will increase as the user continues to shake the device vigorously). This gives the impression of winding up the dancer (displayed in the image) so that s/he will dance for the user. Once the user stops shaking the device, the sequence of images will begin to play, simulating a dance by the individual depicted in the images. The images may or may not include the dancer in various states of undress, but the playing of the sequence of images is such so as to give the impression of a private dance in response to the user's input. Alternatively, instead of commencing the playing of images immediately, the images may begin to play only after the user has affirmatively pressed an appropriate user interface element, such as a hard or soft button. This allows the user to store energy for a later dance at a convenient time/place. Of course, if the user waits too long before playing the images, the dancer may become “bored” and the energy may dissipate, meaning that the user will have to start over by shaking the device and storing new energy.

A dance will last as long as the amount of stored energy, e.g., between 60-90 seconds in one embodiment of the invention for a full energy store. Different dances and/or different models may be delivered via different sequences of images. Selection may be made by the user scrolling through available models/dances or may be made based on other criteria or may be random or pseudo-random according to a shuffle algorithm. Prior to the dance commencing, a splash screen may be displayed to present an advertisement or other message. Alternatively, dances may be interrupted to present such advertisements or messages, or they may be played at the end of the dance. Such advertisements or messages may be sequences of images appended to or included within the dance sequence of images or may be separate sequences of images.

In various embodiments of the invention, users may accumulate points based on their interaction with the application. For example, points may be awarded based on a length of time that a user shakes the device or the length of a dance (e.g., as determined by how much energy a user stores up prior to playing the sequence of images). Other measures if user input, such as frequency of inputs, magnitude of inputs, positions, etc. can form the basis for point awards. Users may compete with one another by recording their individual scores with a remote service provider, for example by positing scores to the service provider's Web site, and may be awarded prizes or other incentives for doing so. For example, users that accumulate sufficient points may be rewarded with free downloads of new sequences of images, or with extended sequences of images that include images not previously viewable by the user. Alternatively, these extended sequences of images may be included in previously downloaded sequences of images but may not be available for viewing until being “unlocked” in response to a user accumulating a sufficiently high score or a sufficiently high aggregate score. The extended sequence of images may include images depicting a fully nude individual or other images.

Other ways in which new or extended sequences of images can be obtained include purchasing or downloading upgraded services from a service provider that provides the image sequences and/or the player application. For example, in response to user input indicating a desire to upgrade (e.g., payment or other indicia indicating a promise to pay received via a commerce application through which a user may purchase upgraded services and/or image sequences), enhanced or extended image sequences may be downloaded to the subject device. Alternatively, instead of an entire image sequence, an unlock code may be downloaded, which unlock code indicates to the player on the subject device that previously non-viewable images in one or more particular image sequences may now be played for viewing. In still other instances, an upgraded player is required to view the enhanced or extended image sequences and such an upgraded player would be provided in response to the user input indicating a desire to upgrade.

FIG. 5F shows a further example of an interface consistent with embodiments of the present invention. This time, shake and touch buttons 98, 100, have been incorporated into the toolbar 56. The functionality provided by these buttons is similar to that described above to the shake and touch icons. Also included in this user interface is a “best time” display 102. This display may report the user's best time for sequencing through all of the images in a particular sequence of images. Similar displays or presentations may be used to present a high score, highest energy, most taps, most shakes, or other metric of interest to the user and/or associated with a game or other contest or which has relevance for accumulating points towards prizes such as those discussed above. As mentioned previously, download button 64 may be used to launch a commerce application (such as the App Store accessible to iPhone users) through which a user can retrieve additional image sequences, such as upgraded or enhanced image sequences, or players, or post his/her scores.

In a system with a Wii remote control (which is communicatively coupled to the Wii video game console via wireless communications means), shaking, rotating, swinging, or another delivery of spatial displacement of the Wii remote control, may result in the display of a sequence or sequences of images in one direction or another on display 14. In the case of a sequence of images showing an individual in various states of undress, the type of spatial displacement of the Wii remote control may be correlated with the type of clothing that is removed. For example, shaking of the Wii remote control may result in the removal of socks, whereas swinging the Wii remote control may result in the removal of a hat. To keep the user entertained, the sequence in which articles of clothing are removed may vary over time. For example, in one instance, the removal of socks may be followed by the removal of a hat. In another instance, the removal of a hat may be followed by the removal of socks.

In another embodiment, the present invention may proceed according to a process which performs steps from any of processes 30, 30′ and 40. For example, scrolling of a trackball may result in the display (in one direction or another) of a sequence of images on display 14. The scrolling of the trackball may be followed by shaking or other spatial displacement, which results in the subsequent display of different images on display 14. Or, shaking may be used to revert to the initial image in a sequence, or to change between different sequences of images. In a variant of the processes described above, the display of subsequent images may be paused (so that a presently displayed image may remain unchanged) even though user input is received. This may be accommodated by a locking function in which user input is ignored or disabled. In another variant, display of a sequence of images may advance to a next image (and further, subsequent images) although no user input is received. This may be accommodated by an automatic mode in which the sequence of images is played without need for user input.

Various alternative entertainment applications in accordance with the present invention may allow for the display of images (in sequence or otherwise) in response to user input in the form of an answer to a question. For example, in addition to or in lieu of user input of the sort described above, the display of a next image in a sequence may depend upon the user providing a correct answer to a question. The question may come in the form of a short message service (SMS) message, a multimedia service message (MSM), an email message, an instant message (e.g., via an instant messenger client installed on the device), or other message, or the user may be prompted to visit a web site at which the question is presented. In some cases, a native application on the device will act as a player for the message, which may be provided to the device via a communication channel accessible to the player.

Regardless of how the question is presented to the user, the user is given the opportunity to answer the question (e.g., by sending a reply message or by entering the requested information into a Web form on a Web page, etc.) In some cases, historical data or other information may be presented to the user in conjunction with the question, so as to serve as a guide or reference point for the user in answering the question being posed. Advertising messages or other content may be displayed in connection with the question and answer (and perhaps other) elements of the game, fostering significant user participation is of interest to game sponsors or organizers.

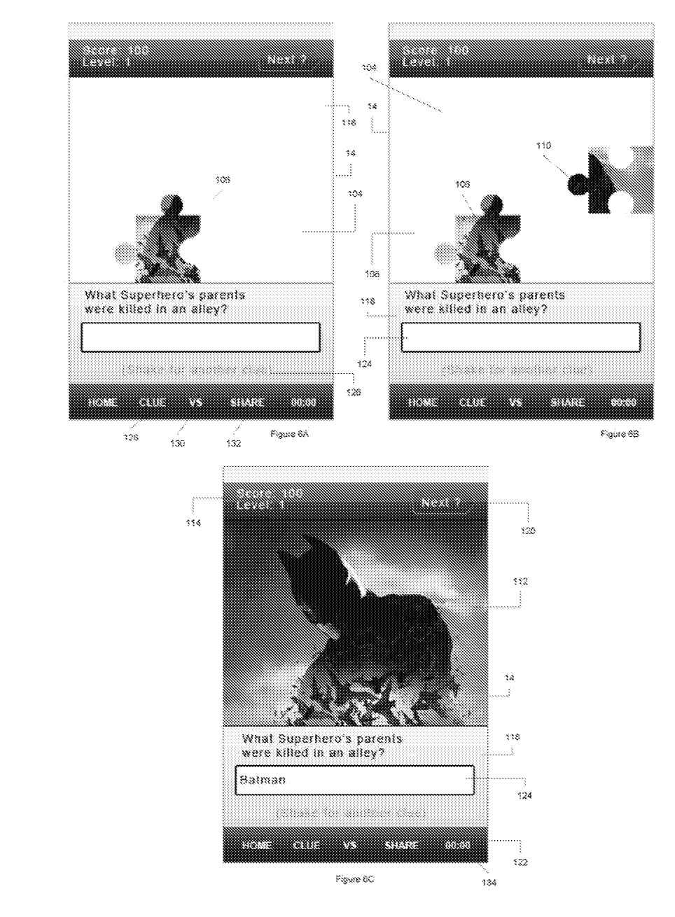

Referring now to FIGS. 6A-6C, still a further embodiment of the present invention is illustrated. In this example, the sequence of images is made to simulate pieces of a jigsaw puzzle. That is, each image in the sequence of images includes successively further details of a complete image, and the details are revealed in each image so as to resemble a jigsaw puzzle being pieced together. For example, among the first images in the sequence may be an image such as image 104 presented on display 14. Image 104 includes mainly a blank background (simulating the absence of jigsaw pieces) with a portion of an image revealed in section 106, which is made to resemble a piece of an unfinished jigsaw puzzle. A later image 108 in the sequence of images includes not only section 106, but also section 110, which resembles a different piece of the jigsaw puzzle. As further images in the sequence are played, additional jigsaw pieces are revealed until a complete image 112 is shown.

The entire user interface includes area 114 to display a score and/or a current level (e.g., for a game having multiple levels of difficultly or other differentiators such as number of questions posed and/or answered); an image area 116, a question and answer area 118 (which may also be used to present instructions or prompts 126 for game play), and a “Next” button or other actuator (which in some cases may be a hard button or a virtual button) 120 to allow a user to progress to a next question (with a corresponding new image sequence) without submitting an answer to a current question. Also provided is a toolbar 122, which affords a user several facilities as discussed below.

This interface provides a convenient means for a user to participate in a trivia game in which a user is presented questions (in the question and answer area 118) and is permitted to submit answers to same (via a text box 124 in the question and answer area). In one embodiment of the game, if a user cannot answer a question based on a current clue and an associated image in the sequence, the user can shake the device (e.g., the iPhone or the Wii remote), or provide another form of user input, and a next image in the sequence will be displayed. The next image will include one or more additional (simulated) jigsaw puzzle pieces, affording the user additional information to attempt to answer the trivia question. In some cases, a different question may be posed when a new image is presented, however, in most instances, the question will remain unchanged.

Users can compete in a local-only version of the game (played on only one device) or in a version which allows for competition against other users via a communication channel accessible to the device on which the game is being played (e.g., via a telecommunication carrier's network or via the Internet, etc.). For example, toolbar 122 includes options for CLUE 128, selection of which will provide the user with a clue to answer the question; VS 130, selection of which allows the user to connect to the carrier's network or the Internet to play against other opponents; and SHARE 132, selection of which allows the user to share the application with other users (e.g., to inform others about the application via email or instant message, which email or instant message may also include a link to a Web site or commerce site to download the application).

To play the game, the user initiates the application and a first image, such as image 104 shown in FIG. 6A will be displayed. In addition, the user will be presented with a question in area 118 (in the illustrated example the question is “What superhero's parents were killed in an alley?”). If the user does not know the answer to the question, s/he can shake the device (or provide other user input) to have a next image in the sequence of images displayed, such as image 108 shown in FIG. 6B. This next image reveals further information that may assist the user in answering the question. This continues until the user correctly answers the question (in this case the correct answer is BATMAN), and the final image in the sequence is revealed (image 112 shown in FIG. 6C). In some cases, the final image may be revealed even if the user does not correctly answer the question. Also, in some cases, if the user provides an incorrect answer, the game may progress to a next image in the sequence to allow the user another opportunity to guess.

In still another embodiment of the game, the user plays against a clock, launched when the user selects the timer button 134 from toolbar 122. In this case, the user may be presented with an indication of the time remaining to submit an answer to the question (e.g., a countdown timer). As time counts down in the timer, images presenting different pieces of the puzzle will be played on the display. The object is to answer the question with as much time remaining as possible. Points may be awarded accordingly and redeemed as discussed above. In some instances during the timed game, when the user shakes the device an additional clue useful for answering the question will be presented. Such a clue may be presented for a brief period of time (e.g., 3 sec or so) and then be removed from view. The clue may be presented in image display area (in which case the playing of images is temporarily halted) or in the question and answer area.

Thus, applications for mobile computing devices have been described. Although the present invention was discussed above in conjunction with several illustrated embodiments thereof, the invention should not be limited to these examples. Instead, the invention should be measured only in terms of the following claims.

What is claimed is:

1. A method, comprising displaying, in response to user input, images from a sequence of images on a display of a mobile device, wherein the sequence of images depict a common constituent in successively different poses or states and the user input comprises entering an answer to a question, or performing at least one of: a touch and drag operation or a tap operation, or shaking of the mobile device.

2. The method of claim 1, wherein the images are displayed in an order determined by a direction implied by the user input.

3. The method of claim 2, wherein the direction is implied by the direction of the touch and drag operation.

4. The method of claim 2, wherein the direction is implied by the direction of the shaking.

5. The method of claim 2, wherein the sequence in winch the images are displayed is determined by a further user input other than the touch and drag operation, the tap operation or the shaking of the mobile device.

6. The method of claim 2, wherein the sequence of images is displayed accompanied by music.

7. The method of claim 1, wherein the sequence of images is displayed in response to the shaking of the device and an additional user input.

8. The method of claim 7, wherein the additional user input comprises an indication that the display of the sequence of images should commence.

9. The method of claim 7, wherein the display of the sequence of images continues for a time determined by the shaking of the device prior to commencement of the display of the sequence of images.

10. The method of claim 1, wherein the sequence of images depicts a human male or female in successively fewer articles of clothing.

11. The method of claim 1, wherein one or more of the sequence of images includes an advertisement.

12. The method of claim 1, wherein advertisements accompany the display of the sequence of images.

13. The method of claim 1, wherein a user is awarded points based on one or more aspects of the user input.

14. The method of claim 13, further comprising displaying the points.

15. The method of claim 13, further comprising awarding prizes based on point totals amassed by the user.

16. The method of claim 1, wherein a user is awarded points based on a duration of play of the sequence of images.

17. The method of claim 16, further comprising displaying the points.

18. The method of claim 16, further comprising awarding prizes based on point totals amassed by the user.

19. The method of claim 1, further comprising providing additional image sequences responsive to additional user input indicative of a request to download the additional image sequences.

20. The method of claim 19, wherein the additional user input includes input received through a download button comprising part of a user interface associated with a player configured to play the images from the sequence on the display.

21. A mobile device, comprising user input means communicatively coupled to processing means, and computer-readable storage means accessible to the processing means and storing a sequence of images each of which depicts a common constituent in successively different poses or states, wherein the processing means is configured to display, on display means communicatively coupled to the processing means, and in response to user input received via the user input means, the images in sequence on the display means, wherein the user input comprises one of answering a question, or performing a touch and drag operation or a tap operation, or shaking of the mobile device.

22. The mobile device of claim 21, wherein the sequence of images depicts a human male or female in successively fewer articles of clothing.

23. The mobile device of claim 21, wherein the processor is configured to display the images in an order determined by a direction implied by the user input.

24. The mobile device of claim 23, wherein the direction is implied by the direction of the touch and drag operation.

25. The mobile device of claim 23, wherein the direction is implied by the direction of the shaking.

26. The mobile device of claim 21, wherein the sequence in which the images are displayed is determined by a user input other than the touch and drag operation, the tap operation or the shaking of the mobile device.

27. The mobile device of claim 21, wherein the processor is configured to display the sequence of images accompanied by music.

28. The mobile device of claim 21, wherein the processor is configured to display the sequence of images in response to the shaking of the device and an additional user input.

29. The mobile device of claim 28, wherein the additional user input comprises an indication that the display of the sequence of images should commence.

30. The mobile device of claim 28, wherein the processor is configured to display the sequence of images for a time determined by the shaking of the device prior to commencement of the display of the sequence of images.

31. A method, comprising displaying, in response to user input received through a remote control unit separate from a processing unit that is communicatively coupled to the remote control unit, images from a sequence of images on a display that is communicatively coupled to the processing unit, wherein the sequence of images depict a common constituent in successively different poses or states and the user input comprises entering an answer to a question, or shaking of the remote control unit.

32. The method of claim 31, wherein the processing unit comprises a Wii video game console and the remote control unit comprises a Wii remote control unit.

33. The method of claim 32, wherein the sequence of images is displayed accompanied by music.

34. The method of claim 32, wherein the sequence of images is displayed in response to the shaking of the remote control unit and an additional user input.

35. The method of claim 34, wherein the additional user input comprises an indication that the display of the sequence of images should commence.

36. The method of claim 32, wherein the display of the sequence of images continues for a time determined by the shaking of the remote control unit prior to commencement of the display of the sequence of images.

37. The method of claim 32, wherein the sequence of images depicts a human male or female in successively fewer articles of clothing.

38. A method, comprising displaying, in response to user input, images from a sequence of images on a display, wherein the sequence of images depict ever increasing portions of an overall image, which overall image includes a visual indication of an answer to a question presented to a user via the display, and the user input comprises spatial displacement of a device configured to recognize said spatial displacement.

39. The method of claim 38, wherein the device is a mobile device which includes the display.

40. The method of claim 38, wherein the device is a remote control unit communicatively coupled to a console unit that is further communicatively coupled to the display.

41. The method of claim 38, wherein upon entry of a correct answer to the question, a final image in the sequence is displayed.

42. The method of claim 38, wherein the device is an iPhone.

43. The method of claim 38, wherein the sequence of images include images simulating pieces of a jigsaw puzzle.
